(19) United States
(12) Patent Application Publication
(10) Pub. No.: US 2018/0071752 A1
(43) Pub. Date: Mar. 15, 2018

(54) Depressants for Mineral Ore Flotation

(71) Applicant: KEMIRA OYJ, Helsinki (FI)

(72) Inventors: Lucas Moore, Dover, FL (US); Xihui Yin, Atlanta, GA (US); Jean Robert Durand, Atlanta, GA (US)

(21) Appl. No.: 15/538,471

(22) PCT Filed: Dec. 18, 2015
(86) PCT No.: PCT/US2015/066719

§ 371 Date: Jun. 21, 2017

Related U.S. Application Data
(60) Provisional application No. 62/097,807, filed on Dec. 30, 2014.

(51) Int. Cl. B03D 1/016; B03D 1/008; B03D 1/01

(52) U.S. Cl. CPC B03D 1/016; B03D 1/008; B03D 2203/02; B03D 2201/06; B03D 1/01

(57) ABSTRACT

Depressants comprising a polymer comprising: a) recurring units of one or more acrylamide monomers; b) recurring units of one or more monomers selected from hydroxyalkyl alkylacrylate, allyloxyalkyldiol, allyloxyethanol, trimethylolpropane allyl ether, and 2-hydroxy ethyl acrylate; and optionally, c) recurring units of one or more acrylic acid monomers are provided. Also disclosed are processes for enriching a desired mineral from an ore comprising the desired mineral and gangue, wherein the process comprises carrying out a flotation process in the presence of one or more of the depressants.

### FIELD OF THE ART

The present disclosure generally relates to depressants for use in mineral ore flotation processes.

### BACKGROUND

Although iron is the fourth most abundant element in the Earth's crust, the vast majority is bound in silicate or more rarely carbonate minerals. The thermodynamic barriers to separating pure iron from these minerals are formidable and energy intensive, therefore common sources of iron used by human industry exploit comparatively rarer high-grade iron oxide minerals, primarily hematite. Most reserves of such high-grade ore have now been depleted, leading to development of lower-grade iron ore sources, for example, magnetite and taconite. The iron content of these lower-grade ores may be concentrated (upgraded) to a higher iron content through various concentration (beneficiation) processes, for example to meet the quality requirement of iron and steel industries.

The processing of lower grade ore sources involves the removal of gangue, which is the unwanted minerals (such as silicates and carbonates) that are an intrinsic part of the ore rock itself. In these beneficiation processes, the gangue is separated using techniques like crushing, grinding, milling, gravity or heavy media separation, screening, magnetic separation, and/or froth flotation to improve the concentration of the desired minerals and remove impurities.

One such beneficiation technique is froth flotation. In froth flotation the ore is ground to a size sufficiently small to liberate the desired mineral or minerals from the gangue. The ground ore is combined with water to generate a slurry containing the mineral particles and the gangue particles. The slurry is then aerated, such as in a tank or column called a flotation cell. Froth flotation physically separates the ground particles based on differences in the ability of air bubbles to selectively adhere to specific mineral surfaces in the slurry. The particles with attached air bubbles are carried to the surface of the slurry, forming a froth that may be removed, while the particles that remain completely wetted stay in the solid/liquid phase.

An additional step that may be utilized in combination with the flotation process involves the removal of the ultra-fine particles by desliming. Ultra-fine particles are generally defined as those less than 5 to 10 microns in diameter. The desliming process may be accompanied by or followed by a flocculation step or some other type of settling step such as the use of a cyclone separating device. This step is typically followed by a flotation step wherein gangue materials are separated from the desired mineral or minerals in the presence of collectors and/or frothers.

The chemistry of the slurry can be modified to control or enhance how certain particles interact with the bubbles or alternatively, settle to the bottom. For example, “collectors,” typically surfactants, can be added to the slurry to interact with the surface of particular particles causing an increase the surface hydrophobicity of the particle and facilitate flotation. “Depressants” can be added to the slurry to selectively interact with the surface of certain particles to reduce the surface hydrophobicity and inhibit the flotation, i.e., facilitate the depression, of that type of particle.

In mineral flotation systems, it is common to depress or hold down the undesirable gangue materials while floating the desirable mineral or minerals. In differential or reverse flotation systems, it is common to depress or hold down the desired mineral or minerals while floating the undesirable gangue. That is, the normal flotation system is reversed with the silicate being enriched in the flotate and the iron ore in the bottom fraction. Such reverse froth flotation systems are disclosed in U.S. Pat. No. 4,732,667.

Common depressants include materials derived from natural substances such as gums, dextrins and starches. See U.S. Pat. No. 3,292,780 to Frommer et al., and U.S. Pat. No. 3,371,778 to Iwasaki and U.S. Pat. No. 4,339,331.

Synthetic depressants have been developed for use in the separation of gangue from desirable minerals, for example, as described in U.S. Pat. Nos. 4,360,425 and 4,289,613, U.S. Pat. No. 2,740,522, U.S. Pat. No. 3,929,629, and U.S. Pat. No. 4,808,301.

Even with the use of depressants in any reverse or differential flotation systems, some portion of the desired minerals may inadvertently be removed with the gangue. That portion of the valuable mineral or minerals that is inadvertently removed with the gangue may be permanently lost from the process. Even a small increase in the recovery or grade of the desired mineral or minerals can result in significant economic benefits.

### BRIEF SUMMARY

In view of the foregoing, one or more embodiments described herein include depressants comprising a polymer comprising: a) recurring units of one or more acrylamide monomers; b) recurring units of one or more monomers selected from hydroxyalkyl alkylacrylate, allyloxyalkyldiol, allyloxyethanol, trimethylolpropane allyl ether, and 2-hydroxy ethyl acrylate; and optionally, c) recurring units of one or more acrylic acid monomers. Also disclosed herein are compositions comprising the depressants and a solvent, as well as processes for enriching a desired mineral from an ore having the desired mineral and gangue, wherein the process comprises carrying out a flotation process in the presence of one or more of the exemplary depressants.

The disclosure may be understood more readily by reference to the following detailed description of the various features of the disclosure and the examples included therein.

### DETAILED DESCRIPTION

According to the various exemplary embodiments described herein, depressants and related compositions and processes may be used to concentrate valuable minerals from mineral-containing ore. Exemplary depressants comprise a polymer comprising: a) recurring units of one or more acrylamide monomers; b) recurring units of one or more monomers selected from hydroxyalkyl alkylacrylate, allyloxyalkyldiol, allyloxyethanol, trimethylolpropane allyl ether, and 2-hydroxy ethyl acrylate; and optionally, c) recurring units of one or more acrylic acid monomers. In particular, the depressants may provide increased flotation process selectivity, decreased collector consumption, decreased sodium hydroxide consumption, and/or decreased landfill, especially as compared to starch-based depressants. The exemplary depressants may also offer an advantage over starch-based depressants because they do not have food value. In exemplary embodiments, the depressants may be provided in a form which renders them easier to dilute and/or directly apply, for example in solution form.

### Definitions

As used herein, “gangue” refers to the undesirable minerals in a material, for example an ore deposit, that contains both undesirable and desired minerals. Such undesirable minerals may include oxides of aluminum, silica (e.g. quartz), titanium, sulfur and alkaline earth metals. In certain embodiments, the gangue includes oxides of silica, silicates or siliceous materials.

As used herein, the terms “desired minerals” or “minerals of value” refer to minerals that have value, and in particular, may be extracted from ore that contains the desired mineral and gangue. Examples of desired minerals include iron powder, hematite, magnetite, pyrite, chromite, goethite, marcasite, limonite, pyrrhotite or any other iron-containing minerals. As used herein, “ore” refers to rocks and deposits from which the desired minerals can be extracted. Other sources of the desired minerals may be included in the definition of “ore” depending on the identity of the desired mineral. The ore may contain undesirable minerals or materials, also referred to herein as gangue.

As used herein, “iron ore” refers to rocks, minerals and other sources of iron from which metallic iron can be extracted. The ores are usually rich in iron oxides and vary in color from dark grey, bright yellow, deep purple, to rusty red. The iron itself is usually found in the form of magnetite (Fe₃O₄), hematite (Fe₂O₃), goethite (FeO(OH)), limonite (FeO(OH).n(H₂O)), siderite (FeCO₃) or pyrite (FeS₂). Taconite is an iron-bearing sedimentary rock in which the iron minerals are interlayered with quartz, chert, or carbonate. Itabirite, also known as banded-quartz hematite and hematite schist, is an iron and quartz formation in which the iron is present as thin layers of hematite, magnetite, or martite. Any of these types of iron are suitable for use in processes described herein. In exemplary embodiments, the iron ore is substantially magnetite, hematite, taconite or itabirite. In exemplary embodiments, the iron ore is substantially pyrite. In exemplary embodiments, the iron ore is contaminated with gangue materials, for example oxides of aluminum, silica or titanium. In exemplary embodiments, the iron ore is contaminated with clay, including for example kaolinite, muscovite, or other silicates.

As used herein, a “collector” refers to an agent that facilitates the flotation of the associated gangue in preference to the flotation of the desired minerals. Typically, collectors are reagents that are used to selectively adsorb onto the surfaces of particles. In some examples, the collector forms a monolayer on the particle surface that essentially makes a thin film of non-polar hydrophobic hydrocarbons. Collectors can be generally classed depending on their ionic charge: they can be nonionic, anionic, or cationic. The nonionic collectors are typically simple hydrocarbon oils. Typical anionic and cationic collectors consist of a polar part that selectively attaches to the mineral surfaces, and a non-polar part that projects out into the solution and makes the surface hydrophobic. For example, common cationic collectors include compounds featuring primary, secondary, and tertiary amine groups. Since the amine group has a positive charge, it can attach to negatively-charged particle surfaces. Collectors can either chemically bond to the mineral surface (chemisorption), or be held on the surface by physical forces (physical adsorption). Examples of collectors include carboxylic acids, sulfates, sulfonates, xanthates and dithiophosphates.

As used herein, a “pH adjuster” or “pH regulator” refers to an agent that is used to change or control. The surface chemistry of most minerals is affected by the pH. For example, in general, minerals typically develop a positive surface charge under acidic conditions and a negative charge under alkaline conditions. Since each mineral changes from negatively-charged to positively-charged at some particular pH, it is possible to manipulate the attraction of collectors to their surfaces by pH adjustment. Exemplary pH adjusters can be acids, for example sulfuric acid, or alkalis, for example with the lime (CaO or Ca(OH)₂) or ammonium hydroxide. Other useful pH adjusters are sodium-based alkalis such as NaOH or Na₂CO₃, wherein the sodium cation generally does not have any significant effect on the particle surface chemistries.

As used herein, a “depressant” is a chemical that inhibits the flotation of minerals to improve the selectivity of a flotation process. A depressant selectively coats mineral surfaces and prevents collector adsorption.

As used herein, the terms “polymer,” “polymers,” “polymeric,” and similar terms are used in their ordinary sense as understood by one skilled in the art, and thus may be used herein to refer to or describe a large molecule (or group of such molecules) that contains recurring units. Polymers may be formed in various ways, including by polymerizing monomers and/or by chemically modifying one or more recurring units of a precursor polymer. Unless otherwise specified, a polymer may be a “homopolymer” comprising substantially identical recurring units formed by, e.g., polymerizing a particular monomer. Unless otherwise specified, a polymer may also be a “copolymer” comprising two or more different recurring units formed by, e.g., copolymerizing two or more different monomers, and/or by chemically modifying one or more recurring units of a precursor polymer. Unless otherwise specified, a polymer may also be a “terpolymer” comprising three or more different recurring units.

As used herein, the term “starch” refers to a carbohydrate consisting of a large number of glucose units joined by glycosidic bonds. It is well established that starch polymer consists mainly of two fractions, amylose and amylopectin, which vary with the source of starch. The amylose having a low molecular weight contains one end group per 200-300 anhydroglucose units. Amylopectin is of higher molecular weight and consists of more, than 5,000 anhydroglucose units with one end group for every 20-30 glucose units. While amylose is a linear polymer having α 1→4 carbon linkage, amylopectin is a highly branched polymer with α 1→4 and α 1→6 carbon linkages at the branch points.

Depressants

In exemplary embodiments, the one or more depressants comprises a polymer comprising: a) recurring units of one or more acrylamide monomers; b) recurring units of one or more monomers selected from hydroxyalkyl alkylacrylate, allyloxyalkyldiol, allyloxyethanol, trimethylolpropane allyl ether, and 2-hydroxy ethyl acrylate; and optionally, c) recurring units of one or more acrylic acid monomers. In exemplary embodiments, the one or more depressants consists essentially of, or is, a polymer comprising: a) recurring units of one or more acrylamide monomers; b) recurring units of one or more monomers selected from hydroxyalkyl alkylacrylate, allyloxyalkyldiol, allyloxyethanol, trimethylolpropane allyl ether, and 2-hydroxy ethyl acrylate; and optionally, c) recurring units of one or more acrylic acid monomers. In exemplary embodiments, the one or more depressants consists essentially of a polymer comprising a) recurring units of one or more acrylamide monomers; b) recurring units of one or more hydroxyethyl methylacrylate monomers; and optionally, c) recurring units of one or more acrylic acid monomers.

In various exemplary embodiments, the polymer may include one or more additional monomers. The one or more additional monomers may be any other suitable monomer, provided the depressant retains the desired functionality described herein.

In exemplary embodiments, the one or more depressants comprises a polymer consisting essentially of: a) recurring units of one or more acrylamide monomers and b) recurring units of one or more monomers selected from hydroxyalkyl alkylacrylate, allyloxyalkyldiol, allyloxyethanol, trimethylolpropane allyl ether, and 2-hydroxy ethyl acrylate. In exemplary embodiments, the one or more depressants comprises a polymer consisting essentially of: a) recurring units of one or more acrylamide monomers and b) recurring units of hydroxyethyl methylacrylate monomers. In exemplary embodiments, the one or more depressants comprises a polymer consisting essentially of: a) recurring units of one or more acrylamide monomers b) recurring units of one or more monomers selected from hydroxyalkyl alkylacrylate, allyloxyalkyldiol, allyloxyethanol, trimethylolpropane allyl ether, and 2-hydroxy ethyl acrylate; and c) recurring units of one or more acrylic acid monomers. In exemplary embodiments, the one or more depressants comprises a polymer consisting essentially of: a) recurring units of one or more acrylamide monomers; b) recurring units of hydroxyethyl methylacrylate monomers; and c) recurring units of one or more acrylic acid monomers.

In exemplary embodiments, the recurring units in the polymer comprise about 10% to about 99%, about 20% to about 99%, about 30% to about 99%, about 40% to about 95%, about 50% to about 95%, about 60% to about 95%, about 70% to about 95%, about 75% to about 90%, about 75% to about 85%, or about 80% to about 85%, of the one or more acrylamide monomers. In exemplary embodiments, the recurring units in the polymer comprise about 3% to about 90%, about 3% to about 80%, about 5% to about 70%, about 5% to about 60%, about 5% to about 50%, about 5% to about 40%, about 5% to about 30%, about 10% to about 30%, or about 15% to about 25% of the one or more hydroxyalkyl alkylacrylate monomers. In exemplary embodiments, the recurring units in the polymer comprise about 3% to about 90%, about 5% to about 90%, about 10% to about 90%, about 20% to about 90%, about 30% to about 80%, about 40% to about 75%, about 50% to about 75%, about 3% to about 50%, or about 10% to about 40%, of the one or more acrylic acid monomers.

In exemplary embodiments, the recurring units in the polymer comprise about 70% to about 95% of the one or more acrylamide monomers and about 5% to about 30% of the one or more monomers selected from hydroxyalkyl alkylacrylate, allyloxyalkyldiol, allyloxyethanol, trimethylolpropane allyl ether, and 2-hydroxy ethyl acrylate.

In exemplary embodiments, the recurring units in the polymer comprise about 75% to about 85% of the one or more acrylamide monomers and about 15% to about 25% of the one or more monomers selected from hydroxyalkyl alkylacrylate, allyloxyalkyldiol, allyloxyethanol, trimethylolpropane allyl ether, and 2-hydroxy ethyl acrylate.

In exemplary embodiments, the one or more acrylamide monomers have been partially hydrolyzed to form the one or more acrylic acid monomers. In exemplary embodiments, the one or more acrylamide monomers are present in the polymers in an amount that is greater than the amount of the one or more acrylic acid monomers.

In exemplary embodiments, the recurring units in the polymer comprise about 5% to about 92% of the one or more acrylamide monomers, about 3% to about 65% of the one or more acrylic acid monomers, and about 5% to about 30% of the one or more monomers selected from hydroxyalkyl alkylacrylate, allyloxyalkyldiol, allyloxyethanol, trimethylolpropane allyl ether, and 2-hydroxy ethyl acrylate.

In exemplary embodiments, the recurring units in the polymer comprise about 25% to about 92% of the one or more acrylamide monomers, about 25% to about 65% of the one or more acrylic acid monomers, and about 5% to about 30% of one or more monomers selected from hydroxyalkyl alkylacrylate, allyloxyalkyldiol, allyloxyethanol, trimethylolpropane allyl ether, and 2-hydroxy ethyl acrylate.

In exemplary embodiments, the recurring units in the polymer comprise about 10% to about 82% of the one or more acrylamide monomers, about 3% to about 65% of the one or more acrylic acid monomers, and about 15% to about 25% of the one or more monomers selected from hydroxyalkyl alkylacrylate, allyloxyalkyldiol, allyloxyethanol, trimethylolpropane allyl ether, and 2-hydroxy ethyl acrylate.

An exemplary acrylamide monomer may be an acrylamide or substituted acrylamide, for example methacrylamide, N-methylol acrylamide, N,N-dimethylacrylamide, N-vinyl formamide, vinylhexanamide, 2-acrylamido-2-methylpropane sulfonic acid, and the like.

In exemplary embodiments, a hydroxyalkyl alkylacrylate monomer comprises a hydroxyalkyl moiety and an alkylacrylate moiety. In exemplary embodiments, the alkyl of the hydroxyalkyl moiety is selected from a C₁₋₆ linear or branched alkyl group, for example methyl, ethyl, propyl, butyl, pentyl, hexyl and all constitutional isomers of such alkyl groups. In exemplary embodiments, the hydroxyalkyl moiety is for example, hydroxymethyl, hydroxyethyl, hydroxypropyl, hydroxybutyl, hydroxypentyl, hydroxyhexyl and the like. In exemplary embodiments, the hydroxy group may be a hydroxyl or the protonated or ionized forms of a hydroxyl, such as an alkali metal salt or ammonium salt of a hydroxy.

In exemplary embodiments, the alkyl of the alkylacrylate moiety is selected from a C₁₋₆ linear or branched alkyl group, for example methyl, ethyl, propyl, butyl, pentyl, hexyl and all constitutional isomers of such alkyl groups. In exemplary embodiments, the alkylacrylate moiety is for example, methylacrylate, ethylacrylate, propylacrylate, butylacrylate, pentylacrylate, hexylacrylate and the like.

An exemplary hydroxyalkylmethacrylate monomer includes, for example 2-hydroxyethyl methacrylate.

In exemplary embodiments, the one or more hydroxyalkyl alkylacrylate monomers comprise hydroxyethyl methylacrylate. In exemplary embodiments, the one or more hydroxyalkyl alkylacrylate monomers consist essentially of hydroxyethyl methylacrylate.

In exemplary embodiments, the one or more hydroxyalkyl alkylacrylate monomers are selected from the monomers of Formula I:

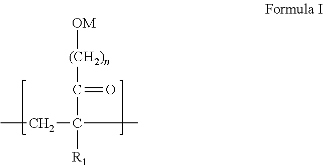

wherein:
R₁ is a C₁₋₆ linear or branched alkyl;
M is selected from the group consisting of H, alkali metal cation or ammonium ion; and
n is in the range from 1 to 6.

In exemplary embodiments the depressant may include additional monomers up to about 3%, about 5%, about 10%, about 15%, about 20%, about 25%, or about 30% of the polymer, provided that the polymer retains its desired functionality, as described herein

In exemplary embodiments, the one or more depressants comprise an acrylamide hydroxyethyl methacrylate polymer. In exemplary embodiments, the one or more depressants consists essentially of an acrylamide hydroxyethyl methacrylate polymer. In alternative embodiments, the one or more depressants comprise a polymer consisting essentially of acrylamide, acrylic acid and hydroxyethyl methacrylate monomers.

In exemplary embodiments, the one or more depressants are not substantially digestible or are not suitable for human consumption.

In exemplary embodiments, the one or more depressants may have any molecular weight so long as the depressants have the effect of selectively depressing the desired minerals in preference to the associated gangue. In exemplary embodiments, the molecular weight of the flocculant is about 200,000 to about 1,000,000; about 250,000 to about 800,000; about 300,000 to about 600,000; about 400,000 to about 600,000, or about 400,000 to about 500,000 Daltons.

In exemplary embodiments, the polymer is linear. In exemplary embodiments, the polymer structure may include branched polymers, star polymers, comb polymers, crosslinked polymers, or combinations thereof.

In exemplary embodiments, the polymer may be made in accordance with any of a variety of polymerization methods. For example, suitable methods of addition polymerization include but are not restricted to free radical polymerization, controlled radical polymerization such as atom transfer radical polymerization, reversible addition-fragmentation chain transfer, nitroxide mediated polymerization, cationic polymerization, or an ionic polymerization. In exemplary embodiments, the polymers may be made by radical or controlled radical polymerization methods. Suitable reaction media include but are not restricted to water solution, aqueous solution (comprising water and polarity changing water soluble organic compounds such as alcohols ethers, esters, ketones and or hydroxy ethers), emulsion, and microemulsion.

The exemplary depressants are generally useful as depressants in a reverse phase flotation process. In particular, the exemplary depressants are effective in selectively depressing the flotation of desired mineral(s) as compared to gangue. In certain embodiments, the exemplary depressants are used to enhance the separation of iron-containing minerals, such as iron oxides or iron powder, from silicate gangue by differentially depressing the flotation of the iron-containing minerals relative to that of the silicate gangue. One of the problems associated with the separation of iron-containing minerals from silicate gangue is that the iron-containing minerals and silicates both tend to float under certain processing conditions. The exemplary depressants change the flotation characteristics of the iron-containing minerals relative to silicate gangue, to improve the separation process.

Compositions

In exemplary embodiments, a composition comprises one or more depressants as described herein, and a solvent. In exemplary embodiments, the solvent is water. In exemplary embodiments, the composition is a solution, for example an aqueous solution.

An exemplary composition may be formulated to provide a sufficient amount of the one or more depressants to a flotation process, i.e., an amount sufficient to produce a desired result.

In an exemplary embodiment, the composition may further comprise one or more agents or modifiers known in the froth flotation art. Examples of such agents or modifiers include, but are not limited to, frothers, activators, collectors, other depressants, acidic or basic addition agents, or any other agent known in the art, provided that the depressant retains its desired functionality, as described herein.

In exemplary embodiments, the composition may include one or more additional depressants in addition to the one or more exemplary depressants. Examples of additional depressants that may be used in combination with the exemplary depressants include but are not limited to: starch; starch activated by treatment with alkali; cellulose esters, such as carboxymethylcellulose and sulphomethylcellulose; cellulose ethers, such as methyl cellulose, hydroxyethylcellulose and ethyl hydroxyethylcellulose; hydrophilic gums, such as gum arabic, gum karaya, gum tragacanth and gum ghatti, alginates; starch derivatives, such as carboxymethyl starch and phosphate starch; and combinations thereof.

In exemplary embodiments, the composition may include one or more collectors or collecting agents, provided that the depressant retains its desired functionality, as described herein.

Processes

According to exemplary embodiments, a flotation process may use one or more of any of the exemplary depressants described herein. In exemplary embodiments, the flotation process may include any known or later developed flotation techniques for separating or concentrating desirable minerals from ore, for example iron from taconite.

In an exemplary flotation process, a slurry (flotation pulp) comprising desired mineral particles, gangue, and water is aerated, such as in a tank or column called a flotation cell. The air bubbles attach to certain particles, carrying them to the surface of the slurry, and forming a froth, which may be removed. Generally speaking, the resulting froth contains primarily those materials which are hydrophobic, and have an affinity for air bubbles. The particles in the slurry that remain wetted stay in the solid/liquid phase.

Exemplary flotation processes take advantage of the differences in hydrophobicity between the desired minerals and the gangue to achieve separation of these materials. In exemplary embodiments, one or more exemplary depressants is added to the flotation system to selectively interact with the surface of the desired mineral particles, resulting in a reduced surface hydrophobicity that improves the depression of the desired mineral particles (i.e., reduces their propensity to float) in the flotation process. In exemplary embodiments, one or more exemplary depressants is added to the flotation system to selectively interact with the surface of certain minerals, resulting in a reduced surface hydrophobicity that improves selectivity in the flotation process.

In exemplary embodiments, the flotation process may be a part of a mineral extraction process. For example, the mineral extraction process may include the steps of grinding crushed ore, classifying the ground ore in water, and treating the classified ore by froth flotation to concentrate the desired minerals. Some of these steps are described in more detail below.

In exemplary embodiments, the flotation process comprises floating the gangue in the froth and recovering the desirable mineral concentrate from the bottom of the cell as the underflow. In other exemplary embodiments, the flotation process comprises inducing the gangue to sink to the bottom of the cell (as underflow) and recovering the desirable mineral concentrate as the overflow (froth). In exemplary embodiments, the flotation process comprises separating iron concentrates from silica and other silaceous materials (gangue) by flotation of the gangue and recovering the iron concentrate as underflow.

In exemplary embodiments, a process for enriching a desired mineral from an ore having the desired mineral and gangue includes carrying out a flotation process in the presence of one or more collecting agents and one or more depressants.

In exemplary embodiments, the desired mineral is an iron-containing mineral, such as iron oxides or iron powder.

In exemplary embodiments, a process for enriching an iron-containing mineral from an ore having the iron-containing material and silicate-containing gangue, includes carrying out a flotation process in the presence of one or more collecting agents and one or more exemplary depressants described herein.

In exemplary embodiments, the flotation process is a reverse or inverted flotation process, for example a reverse cationic flotation process. In such processes, the flotation of the desired mineral is selectively depressed when compared to the flotation of the gangue so as to facilitate separation and recovery of the desired mineral.

In exemplary embodiments, the flotation process is a direct flotation process, for example a cationic or anionic flotation process.

In certain exemplary embodiments, the one or more depressants are added in the form of a composition comprising the depressant and a solvent.

In exemplary embodiments, the one or more depressants may be added at any stage of the process prior to the flotation step.

According to various exemplary embodiments, the amount of depressant to be used in the flotation process is that amount which will depress the flotation of the desired mineral ore or ores to a necessary or desired extent. The amount of depressant added will depend, at least in part, on a number of factors such as the particular ore to be processed, desired mineral and gangue to be separated, the composition of the one or more depressants, the particle size of the gangue and desired mineral, and other conditions of the flotation process. In exemplary embodiments, the amount of depressant used in the flotation process is about 0.01 to about 1.5 kg, about 0.1 to about 0.7 kg, or about 0.2 to about 0.5 kg of depressant per metric ton of ore treated in the reverse flotation process. In exemplary embodiments, the specific consumption of depressant in the process is about 0.01 to about 1.5 kilogram, or about 0.2 to about 0.7 kg of depressant per metric ton of ore to be treated.

According to various embodiments, the amount of depression may be quantified. For example, a percent depression is calculated by measuring the weight percent of the particular mineral or gangue floated in the absence of any depressant and measuring the weight percent of the same mineral or gangue floated in the presence of a depressant. The latter value is subtracted from the former; the difference is divided by the weight percent floated without any depressant; and this value is multiplied by 100 to obtain the percent of depression. In exemplary embodiments, the percent of depression may be any amount that will provide a necessary or desired amount of separation to enable separation of the desirable minerals from gangue. In exemplary embodiments, use of the exemplary depressant causes the flotation of desirable minerals to be depressed by at least about 1%, about 3%, about 5%, about 10%, or about 12%. In exemplary embodiments, use of the depressant causes the flotation of the gangue to be depressed by less than about 7.5% or about 5%.

According to alternative embodiments, the amount of depression may be quantified according to the percent improvement of the mineral grade, i.e., the change in percent by weight of the valuable mineral in the concentrated material compared to the material before the froth flotation process. In exemplary embodiments, use of the disclosed depressant causes valuable metal grade to increase by at least about 0.5%, about 1.0%, about 1.5%, about 2.0% about 3.0%, about 5.0% or about 10% compared to the same process run without the depressant. Even relatively modest amounts of improvement to the recovered metal grade may represent significant increases in production and profitability of the method over time.

In an exemplary process, one or more additional agents and/or modifiers may be added to the ore that is dispersed in water (flotation pulp). Examples of such agents and modifiers include but are not limited to frothers, activators, collecting agents, depressants, acidic or basic addition agents, or any other agent known in the art.

According to the exemplary embodiments, the flotation process may use the exemplary depressant in combination with one or more additional depressants. Examples of additional depressants include: starch; starch activated by treatment with alkali; cellulose esters, such as carboxymethylcellulose and sulphomethylcellulose; cellulose ethers, such as methyl cellulose, hydroxyethylcellulose and ethyl hydroxyethylcellulose; hydrophilic gums, such as gum arabic, gum karaya, gum tragacanth and gum ghatti, alginates; starch derivatives, such as carboxymethyl starch and phosphate starch; and combinations thereof. In certain embodiments, the one or more exemplary depressants are not used in a flotation process with starch.

According to the exemplary embodiments, the flotation process uses the depressants in combination with one or more collectors or collecting agents. In certain embodiments, the one or more depressants are added before or with the addition of collecting agents. In certain embodiments, in one step of the flotation process, one or more collecting agents may be added, for example after the addition of the one or more depressants and any other process agents. In exemplary embodiments, a collecting agent or collector may be added to the flotation pulp. Generally, collecting agents may form a hydrophobic layer on a given particle surface in the flotation pulp, which facilitates attachment of the hydrophobic particles to air bubbles and recovery of such particles in the froth product. Any collecting agent may be used in the exemplary processes. The choice of collector will depend, at least in part, on the particular ore to be processed and on the type of gangue to be removed. Suitable collecting agents will be known to those skilled in the art. In exemplary embodiments, the collector is a cationic collector that is an organic molecule having a positive charge when in an aqueous environment. In certain embodiments, the cationic collectors have a nitrogen group with unpaired electrons present. Cationic collectors which may be used in combination with exemplary depressants are not particularly limited and include: fatty amines, ether amines, amine condensates, alkyloxyalkaneamines, alkoxylated quaternary ammonium compounds and their salts. The fatty amines may be mono-functional or difunctional and the amine functionality may be primary, secondary or tertiary. Similarly, the ether amines may be primary amines or may be difunctional. Ether amines for use as collectors according to the presently disclosed embodiments are not particularly limited and include C₅₋₁₅ aryl or alkyl oxypropyl amines which may be branched or linear, and C₅₋₁₅ branched or linear oxypropyl diaminopropane.

In exemplary embodiments, the collecting agents may be compounds comprising anionic groups, cationic groups or non-ionic groups. In certain embodiments, the collecting agents are surfactants, i.e. substances containing hydrophilic and hydrophobic groups linked together. Certain characteristics of the collecting agent may be selected to provide a selectivity and performance, including solubility, critical micelle concentration and length of carbonic chain.

Exemplary collecting agents include compounds containing oxygen and nitrogen, for example compounds with amine groups. In exemplary embodiments, the collecting agents may be selected from the group consisting of: ether amines, for example primary ether monoamines, and primary ether polyamine; aliphatic C₈-C₂₀ amines for example aliphatic amines derived from various petroleum, animal and vegetable oils, octyl amine, decyl amine, dodecyl amine, tetradecyl amine, hexadecyl amine, octadecyl amine, octadecenyl amine and octadecadienyl amine; quaternary amines for example dodecyl trimethyl ammonium chloride, coco trimethyl ammonium chloride, and tallow trimethyl ammonium sulfate; diamines or mixed amines for example tallow amine, hydrogenated tallow amine, coconut oil or cocoamine, soybean oil or soya-amine, tall oil amine, rosin amine, tallow diamine, coco diamine, soya diamine or tall oil diamines and the like, and quaternary ammonium compounds derived from these amines; amido amines and imidazolines such as those derived from the reaction of an amine and a fatty acid; and combinations or mixtures thereof. In an exemplary embodiment, the collecting agent is an ether amine or mixture of ether amines.

Exemplary collecting agents may be partially or wholly neutralized by a mineral or organic acid such as hydrochloric acid or acetic acid. Such neutralization facilitates dispersibility in water. In the alternative, the amine may be used as a free base amine by dissolving it in a larger volume of a suitable organic solvent such as kerosene, pine oil, alcohol, and the like before use. These solvents sometimes have undesirable effects in flotation such as reducing flotation selectivity or producing uncontrollable frothing. Although these collecting agents differ in structure, they are similar in that they ionize in solution to give a positively charged organic ion.

According to the exemplary embodiments, the quantity of collecting agent used in the flotation process may vary. For example, the amount of collecting agent may depend, at least in part, upon the gangue content of the ore being processed. For example, when processing ores having higher silica, one may utilize a relatively greater quantity of collecting agents. In exemplary embodiments, about 0.01 to about 2 lbs., or about 0.1 to about 0.35 lbs., of collecting agent per ton of ore may be added to the flotation process.

In exemplary embodiments, one type of collecting agent is used in the process. In exemplary embodiments, two or more collecting agents are used in the process.

In exemplary embodiments, one or more frothing agents are used in the process. Exemplary frothing agents are heteropolar organic compounds which reduce surface tension by being absorbed at air-water interfaces and thus facilitate formation of bubbles and froth. Examples of frothing agents include: methylisobutyl carbinol; alcohols having 6-12 carbon atoms which optionally are alkoxylated with ethylene oxide and/or propylene oxide; pine oil; cresylic acid; various alcohols and soaps. In exemplary embodiments, about 0.001 to 0.2 lb. of frothing agent per ton of ore are provided.

According to an exemplary embodiment, the flotation process results in a gangue-enriched flotate (froth) and a bottom fraction rich in the desired mineral (tailings, underflow). In exemplary embodiments the flotate or froth contains silicate. In exemplary embodiments, the bottom fraction contains iron.

According to the embodiments, the flotation process may include one or more steps prior to the flotation step to prepare the ore for flotation. For example, an exemplary process may include the step of grinding the ore, together with water, to a desired particle size, for example a particle size between about 5 and about 200 μm. Optionally, one or more conditioning agents such as sodium hydroxide and/or sodium silicate may be added to the grinding mill prior to grinding the crude ore. In exemplary embodiment, sufficient water is added to the grinding mill to provide a slurry containing approximately 70% solids.

In exemplary processes, the ground ore may be deslimed. For example, the ground ore may be suspended in water, and fine material maybe deslimed, by filtration, settling, siphoning or centrifuging. In exemplary embodiments, the desliming step may be repeated one or more times.

In exemplary processes, an ore-water slurry may be prepared from the ground ore or the deslimed ore, and one or more depressants according to the embodiments may be added to the slurry. In exemplary embodiments, the one or more depressants are added in an amount of about 10 to about 1500 g per ton of ore. In exemplary embodiments, the ore-water slurry may be transferred to a flotation cell and the one or more depressants are added to the ore water slurry in the flotation cell.

In exemplary embodiments, a base or alkali pH adjuster may be added to the slurry to adjust the pH of the slurry. For example, a pH adjuster may be added to the slurry to produce a pH in the range of about 7 to about 11, or about 9 to about 11, or about 10 to about 11. In certain embodiments, the pH is adjusted to about 10.5. In exemplary embodiments, the pH of the slurry in the flotation cell is maintained at between about 7 and about 11 for optimum iron recoveries.

In exemplary embodiments, the flotation process may include a step involving conditioning or agitation of the slurry. For example, once all of the processing agents have been added to the slurry, the mixture is further conditioned or agitated for a period of time before the froth flotation is carried out.

In exemplary embodiments, the flotation process may be performed in a plurality of flotation processing steps. For example, the flotation process may be performed in flotation units containing a plurality of communicating cells in series, with the first cell(s) being generally used for the rougher flotation, and subsequent cell(s) being used for the cleaner flotation. In exemplary embodiments, each flotation cell may be any flotation equipment, including, for example, the Denver laboratory flotation machine and/or the Wemco Fagergren laboratory flotation machine, in which the slurry mixture is agitated and air is injected near the bottom of the cell as desired.

In exemplary embodiments, before flotation treatment the ore-water slurry comprises about 20 to about 40% by weight solids. In exemplary embodiments, the duration of the flotation process depends upon the desired result. In exemplary embodiments, the time of flotation treatment may be from about 1 to 10 minutes for each circuit. The time of the flotation process may depend at least in part upon the gangue content, the grain size of the ore being treated and the number of flotation cells involved.

According to the embodiments, the flotation process includes a rougher flotation treatment, in which the gangue may be selectively separated from the ore and removed with the flotation froth. The desired mineral concentrate from the flotation treatment is removed as the underflow and isolated as the rougher concentrate. In exemplary embodiments, the concentrate of the desirable mineral in the rougher concentrate is found to contain a sufficiently low quantity of gangue to be suitable for almost any desired use.

In exemplary embodiments, the flotation froth, the rougher concentrate, or both may be further processed. For example, in exemplary embodiments, the overflow or froth from the rougher flotation may be advanced to a first cleaner flotation cell where a second flotation treatment is performed. The underflow from this first cleaning flotation cell is an mineral concentrate identified as the first cleaner middlings which generally will contain more gangue than the rougher concentrate but significantly less gangue than the original crude ore. The overflow frothing from the first cleaning cell may be advanced to a second cleaning flotation cell where the flotation procedure is repeated and another mineral concentrate is obtained which is identified as the second cleaner middlings. In exemplary embodiments, the froth flotation cleaning is repeated one or more times. Any or all of the cleaner middlings may be combined with a rougher concentrate to provide an upgraded mineral ore concentrate. The extent to which the rougher concentrate is combined with the various middling fractions will depend upon the desired mineral content of the final product derived from the procedure. As an alternative embodiment, the cleaner middlings may be returned and recycled through the rougher flotation cell to further upgrade these cleaner middlings.

The depressants, compositions and processes of the exemplary embodiments can be used to provide higher selectivity and desired mineral recoveries as compared to other depressants when used in cationic flotation processes. In exemplary embodiments, the mineral concentrate, e.g. hematite concentrate, that is obtained by the exemplary processes meets the specifications for the steel industry. In exemplary embodiments, the depressants, compositions and processes can be used to maximize the iron recovery to increase production of metallic charge per unit ore fed, which may provide increases in production and profitability.

In exemplary embodiments, the depressants, compositions and processes described herein can be used to improve the grade of iron from iron ore such that the grade of the recovered iron is at least about 55%, about 56%, about 57%, about 58%, about 59%, about 60%, about 61%, about 62%, or about 63%. In exemplary embodiments, the depressants, compositions and processes described herein can be used to improve the grade of iron from iron ore such that the grade of the recovered iron is in the range of about 55% to about 64%, about 56% to about 64%, about 57% to about 64%, about 58% to about 64%, or about 59% to about 64%.

In exemplary embodiments, the depressants, compositions and processes described herein can be used to improve the grade of iron from iron ore by at least about 0.5%, about 1%, about 1.5%, about 2%, about 2.5%, about 3%, about 3.5%, about 4%, about 4.5%, about 5%, about 5.5%, or about 6%. For example, the depressants, compositions and processes described herein can be used to improve the grade of iron from iron ore with an initial iron grade of about 56% to a grade of at least about 56.5%, about 57%, about 57.5%, about 58%, about 58.5%, about 59%, about 59.5%, about 60%, about 60.5%, about 61%, about 61.5%, or about 62%. In exemplary embodiments, the depressants, compositions and processes described herein can be used to improve the grade of iron from iron ore by about 0.5% to about 7%, about 1% to about 7%, about 1.5% to about 6%.

In exemplary embodiments, the depressants, compositions and processes described herein can be used to improve the grade of iron oxide from iron ore such that the grade of the recovered iron oxide is at least about 80%, about 81%, about 82%, about 83%, about 84%, about 85%, about 86%, about 87%, or about 88%. In exemplary embodiments, the depressants, compositions and processes described herein can be used to improve the grade of iron oxide from iron ore such that the grade of the recovered iron oxide is in the range of about 80% to about 90%, about 82% to about 90%, or about 82% to about 88%.

In exemplary embodiments, the depressants, compositions and processes described herein can be used to improve the recovery of iron from iron ore to at least about 60%, about 62%, about 65%, about 70%, about 75%, about 80%, about 85%, or about 90%. In exemplary embodiments, the depressants, compositions and processes described herein can be used to improve the recovery of iron from iron ore such that the recovery of iron is in the range of about 60% to about 95%, about 70% to about 95%, or about 70% to about 93%.

In exemplary embodiments, the depressants, compositions and processes can be used to reduce the amount of silica in the iron ore to less than about 20%, about 15%, about 10%, about 9%, about 8%, about 7%, about 6%, about 5%, about 4%, about 3%, or about 2%.

The following examples are presented for illustrative purposes only, and are not intended to be limiting.

### EXAMPLES

General Protocol for Flotation Tests

Flotation tests described herein were generally performed with iron pulp samples according to the following procedure:

The sample was pre-mixed well in a bucket with an overhead mixer and then representative samples were split from the bucket.

Using a calibrated pH meter, a make-up water (to keep the level of the recipient of the flotation cell constant) is prepared by adjusting its pH (for example to pH 10.5 with NaOH 5% or acetic acid 10%) to a desired value.

The collector solution of amine, for example an ether amine (concentration is, for example, 1 wt %), is prepared as well as the depressant and frother solution (concentration is, for example, 1 wt %). Preparation of the depressant solution must take into account its moisture and organic content.

The flotation cell (1 L) is weighed and the required amount of pulp for flotation is added as follows: a dry mass of pulp is added, up to its half, completing the other half with the required quantities of collector and depressant solutions and with “water” (liquid) filtered from the sample of the pulp received. (Note: the capacity of the flotation cell is measured up to the height of the blades.) The addition of these materials is made as follows:
1) The “water” volume needed for sample homogenization is added.
2) The extractor is downloaded up to the limit, switching on the rotation (950 rpm). The initial pH is measured and recorded.
3) The mass of depressant solution is added in and conditioned and/or agitated for a period of time, for example 5 minutes, observing the pH. If the pH stabilizes at a desired value (for example between about pH 6 to about 10, such as about 7.5), no adjustment is needed. Otherwise, pH modifiers (for example 5% NaOH and/or acetic acid solution 10%) may be added to adjust the pH to the desired value.

After the conditioning and/or agitation and if necessary, pH adjustment, the mass of amine collector solution is added to the recipient vessel and the remaining volume of the tank is completed with remaining calculated “water” from the sample, for a given pulp solids %. This mixture is conditioned or agitated for a period of time, for example 1 minute. Collection trays are weighed and their weighs recorded.

With the flotation cell and the collection trays put together, maximum aeration and collecting shovels are switched on, starting to count the timing of flotation (chosen according to each test). The level of recipient is kept constant by the use of make-up water, already prepared previously with a desired pH, for example a pH of 8.

At the end of the test, the flotation cell is cleaned taking the necessary care for no contamination of the materials floated and sunk.

The floated (gangue) and sunk (concentrate) materials are collected in the weighed trays during the time chosen for collection. The samples are subsequently dried at 105° C. until constant weight is achieved.

The trays containing the float and sunk materials are weighed and recorded. A quantity of each material is sent for analysis of iron, silica, alumina and phosphorus.

### Example 1: Flotation Test with Iron Ore and Exemplary Depressant Comprising Acrylamide/Hydroxyethyl Methacrylate Polymer

In this example, flotation tests were conducted on a laboratory scale and the objective of these tests were to separate the mineral of interest (hematite) from gangue. The general protocol for flotation tests as described above was used for these experiments. The depressant used for these experiments was acrylamide/hydroxyethyl methacrylate polymer comprising 0.2 mole fraction hydroxyethyl methacrylate and 0.8 mole fraction acrylamide and having a molecular weight of about 300,000. In this raw iron ore sample, the values of iron and silicate were 54.595% (55.01% and 54.18%) and 19.68% (19.07% and 20.29%), respectively.

It was observed that flotation tests using the depressant resulted in an increase in the iron grade from 55.01% to 61.60% and that Fe recovery was maintained at a similar level as a flotation process that did not use any depressant agents. At depressant concentrations of 300 g/T, the flotation process resulted in increased iron concentration in the final sample compared to a similar process without any depressant (see Table 1). The flotation process using the depressant resulted in iron ore samples with smaller amounts of silicate as compared to samples from a process with no depressant (see Table 1).

TABLE 1
Chemical Analysis of Iron Ore Resulting from Flotation

| | Without Depressant | Depressant |
|---|---|---|
| Depressant Amount (g/ton) | 0 | 300 |
| Collector Amount (cc/ton) | 220 | 220 |
| Frother (cc/ton) | 50 | 50 |
| pH | 7.3 | 7.3 |
| Time (min) | 3 | 3 |
| Agitation (rpm) | 800 | 800 |
| Mass recovery (%) | 64.34 | 60.82 |
| Fe Grade in Concentrate (wt %) | 58.03 | 61.60 |
| SiO₂ in Concentrate (wt %) | 14.8 | 9.57 |
| Fe Recovery (%) | 68.9 | 68.11 |

In the preceding procedures, various steps have been described. It will, however, be evident that various modifications and changes may be made thereto, and additional procedures may be implemented, without departing from the broader scope of the exemplary procedures as set forth in the claims that follow.

1. A depressant comprising a polymer comprising a) recurring units of one or more acrylamide monomers; b) recurring units of one or more monomers selected from hydroxyalkyl alkylacrylate, allyloxyalkyldiol, allyloxyethanol, trimethylolpropane allyl ether, and 2-hydroxy ethyl acrylate; and optionally, c) recurring units of one or more acrylic acid monomers.

2. The depressant of claim 1, wherein the polymer comprises recurring units of one or more hydroxyalkyl alkylacrylate monomers.

3. The depressant of claim 1, wherein the recurring units in the polymer comprise about 70% to about 95% of the one or more acrylamide monomers and about 5% to about 30% of the one or more monomers selected from hydroxyalkyl alkylacrylate, allyloxyalkyldiol, allyloxyethanol, trimethylolpropane allyl ether, and 2-hydroxy ethyl acrylate.

4. The depressant of claim 2, wherein the one or more hydroxyalkyl alkylacrylate monomers comprises a hydroxyalkyl moiety and an alkylacrylate moiety.

5. The depressant of claim 4, wherein the alkyl of the hydroxyalkyl moiety is selected from a C₁₋₆ linear or branched alkyl and wherein the alkyl of the alkylacrylate moiety is selected from a C₁₋₆ linear or branched alkyl.

6. The depressant of claim 2, wherein the one or more hydroxyalkyl alkylacrylate monomers comprises hydroxyethyl methylacrylate.

7. The depressant of claim 1, wherein the recurring units in the polymer comprise about 5% to about 92% of the one or more acrylamide monomers, about 3% to about 65% of the one or more acrylic acid monomers, and about 5% to about 30% of the one or more monomers selected from hydroxyalkyl alkylacrylate, allyloxyalkyldiol, allyloxyethanol, trimethylolpropane allyl ether, and 2-hydroxy ethyl acrylate.

8. A composition comprising: one or more depressant according to claim 1; and a solvent.

9. The composition of claim 7, wherein the solvent is water.

10. A process for enriching a desired mineral from an ore comprising the desired mineral and gangue, wherein the process comprises carrying out a flotation process in the presence of one or more depressants according to claim 1.

11. The process of claim 9, wherein the desired mineral is an iron-containing mineral.

12. The process of claim 9, wherein the gangue comprises oxides of silica, silicates or siliceous materials.

13. The process of claim 9, wherein the flotation process is a reverse cationic flotation process.

14. The process of claim 9, wherein the one or more depressants is added in the form of a composition comprising the depressant and a solvent.

15. The process of claim 13, wherein the solvent is water.

16. The process of claim 9, wherein the improves the grade of iron from iron ore such that the grade of the recovered iron is at least about 61%.

17. The process of claim 9, wherein the process reduces the amount of silica in the iron ore to less than about 10%.
